(19) United States
(12) Patent Application Publication
(10) Pub. No.: US 2016/0047220 A1
(43) Pub. Date: Feb. 18, 2016

(54) Drilling Planning System

(71) Applicant: Trimble Navigation Limited, Sunnyvale, CA (US)

(72) Inventors: Alan Sharp, Superior, CO (US); Morgan Mattsson, Trollhättan (SE)

(21) Appl. No.: 14/825,635

(22) Filed: Aug. 13, 2015

Related U.S. Application Data
(60) Provisional application No. 62/036,937, filed on Aug. 13, 2014.

(51) Int. Cl. E21B 44/02; G06Q 50/02; G05B 15/02; E21B 47/024

(52) U.S. Cl. CPC E21B 44/02; E21B 47/024; G06Q 50/02; G05B 15/02

(57) ABSTRACT

A drilling system has one or more drilling machines at a drilling site, in communication with a drill planning computer. The drill planning computer includes one or more processors, and a non-transitory computer readable medium in communication with the one or more processors having encoded thereon a set of instructions executable by the one or more processors to receive drill plan parameters, generate a drill plan based on the drill plan parameters, communicate the drill plan to one or more drilling machines, execute the drill plan with the one or more drilling machines, update at least one of the drill plan parameters based on an identified change in drilling conditions, update the drill plan in real-time based on an updated drill plan parameter, and adjust operation of the one or more drilling machines to reflect the changes in the updated drill plan.

### CROSS-REFERENCES TO RELATED APPLICATIONS

This application claims priority to U.S. Provisional Patent Application Ser. No. 62/036,937, filed on Aug. 13, 2014 by Alan Sharp (attorney docket no. 0420.21/PR2), entitled, “Drilling Planning System,” the disclosure of which is incorporated herein by reference in its entirety and for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to the parametric design and modelling solutions, and more particularly to systems and methods of parametric drill planning capable of automated and dynamic adjustment to actually encountered conditions.

### BACKGROUND

Many construction projects require removal of significant amounts of earth. Examples can include tunnels, roadways through mountainous areas, mines, and the like. Another example can include the pouring of pilings to support various structures. In many cases, the earth to be removed is sufficiently rocky to require destructive removal techniques, such as drilling and blasting. In many blasting operations, precise location, orientation, and/or depth of drill holes can ensure that the earth is removed in accordance with the project plan and as efficiently as possible. Similarly, for piling operations, effective planning can help to optimize the amount of piling material needed and the structural support provided by the pilings. While some simple solutions exist to assist with such planning, these solutions lack important features and are not integrated with the project workflow.

There is a need for a tool that can provide integrated drill planning and control functionality, to enhance the effectiveness and economy of drilling, blasting, and piling operations.

### BRIEF SUMMARY

According to a set of embodiments, a system, apparatus, and method for drill planning are provided.

The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In one aspect, a method for drill planning is provided. A drill planning computer system may receive one or more drill plan parameters. The computer system may generate a drill plan based on the one or more drill plan parameters, the drill plan comprising a three-dimensional model specifying positions, depths, and inclinations for a plurality of holes to be drilled in a construction project. The computer system may then communicate the drill plan to one or more drilling/piling machines. The one or more drill planning machines may execute the drill plan to drill one or more holes in a material, in accordance with the drill plan. The one or more machines may identify a change in at least one of the one or more drill plan parameters corresponding to at least one of a calculation or measurement based on conditions at the project site. The computer system may then receive an at least one updated drill plan parameter, the at least one updated drill plan parameter being based on the at least one of the calculation or measurement of conditions at the project site. The computer system may update the drill plan, in real-time, based on the at least one updated drill plan parameter to create an updated drill plan. The computer system may then communicate the updated drill plan to the one or more machines to be executed, wherein operation of the one or more machines previously executing the drill plan are adjusted in real-time to reflect changes made by the updated drill plan.

In some embodiments, the drill plan may include a minimum drill depth parameter that is communicated to the one or more machines, wherein executing the drill plan causes each of the one or more machines to drill each bore hole to at least a depth specified by the minimum drill depth parameter. In another embodiment, the drill plan parameter may be a positional element, indicating at least one of a geographic position, drill orientation, inclination, elevation, and tilt.

In one set of embodiments, the drill plan parameter may be tied to a production metric. The computer system may then calculate, based on the one or more drill plan parameters, an expected production metric associated with the drill plan. The one or more machines may identify whether the expected production metric is being met. The computer system may calculate an updated expected production metric based on the at least one updated drill plan parameter. The computer system may further adjust at least one other drill plan parameter of the one or more drill plan parameter to maintain the expected production metric of the drill plan, where the updated drill plan reflects the adjustments to maintain the expected production metric of the drill plan. In some embodiments, the drill plan may be a corridor drill plan. Thus, the computer system may calculate a plurality of benches, each bench having its own split and blast hole pattern, wherein the split and blast hole patterns are each expected production metrics. In a further set of embodiments, the computer system may automatically select a type, a quantity, and/or a mix of explosives necessary to execute the drill plan, based on the one or more drill plan parameters, wherein the type, quantity, and mix are each expected production metrics. In some embodiments, the computer system may also design a blast sequence to implement the drill plan, based on the one or more drill plan parameters, wherein the blast sequence is one of the expected production metrics. The computer system may also estimate blasting costs associated with the drill plan, based on the one or more drill plan parameters, wherein the blasting costs are expected production metrics. In yet further embodiments, the computer system may automatically estimate, with the computer, one or more drill times to execute the drill plan, based on the one or more drill plan parameters, wherein the drill times are expected production metrics. In yet another set of embodiments, the computer system may estimate production volumes and/or production rates of material excavated by executing the drill plan, based on the one or more drill plan parameters, wherein the production volumes and production rates are each expected production metrics. The computer system may further estimate haulage requirements and/or schedule to remove the material excavated, based on the one or more drill plan parameters, wherein the haulage requirements and schedule to remove the material are each expected production metrics.

According to an additional set of embodiments, the computer system may define a quality metric, the quality metric including at least a tolerance range, implement the quality metric into the drill plan, measure the quality metric for a drill hole, as drilled by the one or more machines, and determine whether the quality metric as measured for the drill hole is within the tolerance range. In some embodiments, the computer system may also define a progress measurement based on the quality metric, track the quality metric for each drill hole of a drill plan, and determine progress made on the progress measurement based on a number of drill holes determined to be within the tolerance range.

In another aspect, a drill planning computer is provided. The drill planning computer may include one or more processors, a communications interface in communication over a communications network, wherein the communications interface is communicatively coupled to one or more machines of a drilling operation, and a non-transitory computer readable medium in communication with the one or more processors, the computer readable medium having encoded thereon a set of instructions. The set of instructions may be executable by the one or more processors to receive one or more drill plan parameters, generate a drill plan based on the one or more drill plan parameters, communicate, via the communications interface, the drill plan to one or more machines, receive, via the communications interface, a change in at least one of the one or more drill plan parameters corresponding to at least one of a calculation or measurement based on conditions at the project site by the one or more machines, update the at least one of the one or more drill plan parameters based on the change, update the drill plan in real-time based on the at least one updated drill plan parameter to create an updated drill plan, transmit, via the communications interface, the updated drill plan to the one or more machines, and adjust, in real-time, operation of the one or more machines to reflect the changes in the updated drill plan.

According to a set of embodiments, the drill planning computer may further calculate, based on the one or more drill plan parameters, an expected production metric associated with the drill plan, identify, with the at least one of the one or more machines, whether the expected production metric is being met, and calculate an updated expected production metric based on the at least one updated drill plan parameter. The drill planning computer may also define a quality metric, the quality metric including at least a tolerance range, implement the quality metric into the drill plan, measure, via the one or more machines, the quality metric for a drill hole as drilled by the one or more machines, receive, via the communications interface, the measurement of the quality metric from the one or more machines, and determine whether the quality metric as measured for the drill hole is within the tolerance range.

In a final aspect, a system for drill planning is provided. The system may include one or more drilling machines at a drilling site, the one or more drilling machines comprising a communications interface and one or more sensors, a drilling supervisor computer in communication over a communications network, the drilling supervisor communicatively coupled to the one or more drilling machines, and a drill planning computer. The drill planning computer may further include one or more processors, a network interface communicatively coupled to the communications network, wherein the network interface is in communication with the drilling supervisor and the one or more drilling machines via the communications network, and a non-transitory computer readable medium in communication with the one or more processors, the computer readable medium having encoded thereon a set of instructions executable by the one or more processors. When executed, the instructions cause the processor to receive one or more drill plan parameters, generate a drill plan based on the one or more drill plan parameters, communicate, via the communications interface, the drill plan to one or more machines, retrieve, from at least one of the one or more machines, a change in at least one of the one or more drill plan parameters corresponding to at least one of a calculation or measurement based on conditions at the project site, update the at least one of the one or more drill plan parameters based on the change, update the drill plan in real-time based on the at least one updated drill plan parameter to create an updated drill plan, transmit, via the communications interface, the updated drill plan to the one or more machines, and adjust, in real-time, operation of the one or more machines to reflect the changes in the updated drill plan, wherein the drilling supervisor computer receives the updated drill plan from the drill planning computer and controls at least one of the drilling machines to execute the updated drill plan by drilling one or more holes.

In one set of embodiments, the system may further contain instructions that cause the processor to calculate, based on the one or more drill plan parameters, an expected production metric associated with the drill plan, identify, with the at least one of the one or more machines, whether the expected production metric is being met, and calculate an updated expected production metric based on the at least one updated drill plan parameter. Instructions may also include instructions to define a quality metric, the quality metric including at least a tolerance range, implement the quality metric into the drill plan, measure, via the one or more machines, the quality metric for a drill hole as drilled by the one or more machines, receive, via the communications interface, the measurement of the quality metric from the one or more machines, and determine whether the quality metric as measured for the drill hole is within the tolerance range.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a system drawing illustrating a drill planning and control system, in accordance with various embodiments.

FIG. 2 is a generalized schematic diagram illustrating a computer system, in accordance with various embodiments.

FIG. 3A is a flow diagram of a method for drill planning, in accordance with various embodiments.

FIG. 3B is a flow diagram of a set of additional processes in a method for drill planning, in accordance with various embodiments.

FIG. 3C is a flow diagram of a set of additional processes in a method for drill planning, in accordance with various embodiments.

FIG. 3D is a flow diagram of a set of additional processes in a method for drill planning, in accordance with various embodiments.

FIG. 4 is a block diagram of a drill planning system topology, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

A set of embodiments provides tools and techniques for planning, controlling, and/or executing a drilling project. The tools provided by various embodiments include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible and/or non-transitory computer readable media (such as, to name but a few examples, optical media, magnetic media, and/or the like).

For example, in an aspect, some embodiments include a drilling system that utilizes GPS positioning, along with a computer executing software that navigates a drill/piling machine into position. In some aspects, the software controls the tilt of the mast in the pitch and roll axes of the machine (for vertical/inclined drilling/piling); alternatively and/or additionally, the software can also control the depth of the drilling system to navigate a drill bit or pile into the correct position, orientation, inclination and/or elevation. In another novel aspect, the software can provide a number of advanced drill planning and/or drill analysis functions and/or can provide a turnkey solution that enables the creation of drill plans in an automated way for a variety of scenarios, allowing automatically and/or parametrically drill planning for the design criteria.

Further examples of features provided by various embodiments include, but are not limited to the following:

1) Parametric Drill Plan Design—the software can allow a user to design a drill plan using a target Design surface (Corridor, Road, plane or surface model, to name a few examples), a rock surface model (e.g., measured or computed from borehole data) and a parametric drill plan that allows for the creation of Split and Blast holes of differing sizes and in differing patterns depending on the scenario selected. The parametric nature of the drill plan can allow any parameter to be changed, and the software can automatically update the drill plan to reflect that change—i.e. a surface model update or a parameter change in the drill plan will trigger the drill plan to update and reflect the change, which can involve automated changes to various other parameters (e.g., locations, sizes, and/or orientation of bore holes) to accommodate the change(s) input by the user, or encountered on the ground at a project site.

2) Corridor drill plans with automated multiple bench computations—when excavating large rock cuttings for a corridor project, multiple benches are sometimes required (i.e., to remove rock in vertically organized sections or benches). Each section creates a new bench, which has its own split and blast hole pattern. Each pattern can be arranged geometrically to fit the width of the corridor and to maximize the blast capability for the minimum number of holes with accurate depth and position, orientation and inclination angles. In some aspects, each drill plan is machine ready, which allows the drilling/piling machine to work in automated fashion directly from the designed drill plan.

3) In some embodiments, the software can pass minimum drill depth parameters to the machines. This can allow the machines to adjust drilling operations “on the fly” (i.e., without ceasing operations), in line with changes found in ground conditions at a project site. For instance, the plan may start with boreholes to obtain a rough idea of where the rock interface will be. Once exposed, however, the rock interface might be higher or lower than thought. The minimum drill depth parameter can ensure that the machine drills a minimum depth into the rock itself, which increases safety on running the blast operation. Boreholes of insufficient depth have the effect of blasting too violently, which can send rock fragments flying great distances, creating the potential for injury and property damage. In an aspect, the system can employ an extension to the International Rock Excavation Data Exchange Standard (“IREDES”) to communicate such changes.

4) In some embodiments, the drill plan is developed on a separate office computer system, and the parametric plan can be transmitted to the drilling/piling machine (e.g., using the extended IREDES standard) for execution. In an aspect, some embodiments allow adjustment of the drill plan on the fly in the machine based on the results of the first drill and blast operation. For example, the system can use the first process to improve the second round iteratively, and the second round to improve a third round, and so on and so forth. This feature can eliminate the need to return to the office computer to reconfigure the drill plan for such adjustments after each round of the drilling and blasting process.

5) In some cases, the software can be integrated with other surveying/construction management software, such as Business Center™, available from Trimble Navigation. This integration can allow the drill planning process to be integrated with other project planning and management workflows. Additionally, and/or alternatively, the parametric plan can be visualized in three-dimensional views of such software (and/or the native drill planning software), so a user can validate the design of the drill plan.

6) Other types of integration are possible as well. For example, the drill planning software can be integrated with explosives management and planning features. For example, the software can the design and/or actual drilled hole data (which can be obtained from the machines and/or from other measurements) to plan the appropriate type and mix/quantity of explosive for each hole and to create the blast sequence design to maximize the effectiveness of the explosives. This can provide for accurate estimation of production volumes, production rates, quantities of explosives needed, tracking of explosives placed, estimating drill times and all associated costs of the planning and execution process. Similarly, the drill planning tool can be integrated with a production monitoring system. For example, the blasted volume can be computed and added to the production schedule, along with haulage equipment machine metrics to compute the time and loads required to haul away and place the material elsewhere on the project.

7) In some embodiments, the system can also provide Drill Plan Management on site. For example, in one aspect, certain embodiments can enable drilling or piling machines to communicate with each other. Merely by way of example, if three machines are working on the same plan, each drill can see what each of the other drills has done in real time. As another example, each machine can relay similar information to a drill supervisor so that the supervisor can see, in real time, progress of operations. Machines can also relay such information to back office planning and scheduling staff so they, too, can see progress, and plan and schedule operations. In another aspect, some embodiments can track some or all operational costs (e.g., drill consumables) and some or all production outages to improve production operations. Operational costs and other cost-related measures may be utilized in drill planning as a parameter or part of parameter in the design of the drill plan. Thus, expected operational costs may be updated within the parametric design of the drill plan according to actual reported or tracked operational costs.

8) Some embodiments can integrate with other planning and design tools as well. Merely by way of example, the software can be configured to interface with design applications such as Tekla Structures™, and can leverage structural design elements from such applications in the planning process (e.g., for piling operations).

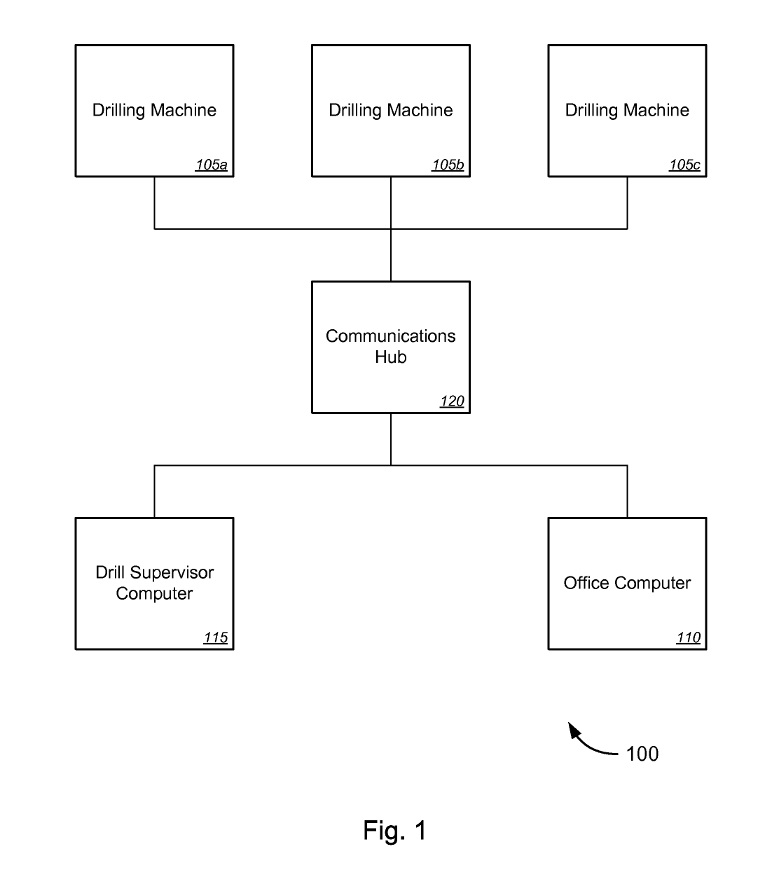

The accompanying descriptions of FIGS. 1-4 are provided for purposes of illustration only, and should not be considered to limit the scope of the different embodiments. FIGS. 1-4 may refer to examples of different embodiments corresponding to various stages in a process, or parts of the drill planning system, each of which can be considered alternatives or complements to one another in the various embodiments.

FIG. 1 illustrates an exemplary system 100 in accordance with one set of embodiments. The system 100 can include one or more drilling/piling machines 105 (although three machines 105 are illustrated in FIG. 1, different embodiments can employ any suitable number of machines 105). In an aspect, each of the machines 105 might be involved in the same drilling/piling project and/or might operate according to the same drill plan. A variety of different types of equipment can be implemented as a drilling/piling machine in the system 100, according to different project needs. Merely by way of example, the MD5150 Track Drill™ from Caterpillar Inc. can be used as a drilling machine 105 in accordance with some embodiments. In an aspect, the machine 105 includes a control system (discussed below) that interfaces with other system elements to receive a drill plan and control the machine 105 to execute the drill plan. The DPS900™, available from Trimble Navigation Limited, is one example of a control system that can be used in accordance with some embodiments.

The system 100 further comprises an office computer 110, which might be a personal computer, engineering workstation, or the like. In an embodiment, the office computer 110 is programmed with the drill planning software, one example of which is Trimble Business Center-HCE™. This software can perform many of the functions and methods described herein. In general, the office computer 110 (and the software with which it is programmed) can be used by a user to develop a drill plan, which will be executed by the machines 105. The office computer 110 generally will be located off-site from the project (e.g., at an office of an engineering firm responsible for the project), although this is not required. The office computer 110, however, can be in communication with each of the machines 105, through a variety of methods, described in further detail below.

In some embodiments, the system 100 can also include a drill supervisor computer 115, which can be located at the project site and can perform on-site management of the project. The drill supervisor computer 115 might be, for example, a laptop computer, a tablet computer, a specialized handset, a smart phone, or the like. In some cases, the drill supervisor computer 115 operates a version of the drill planning software that provides some or all of the functionality of the software on the office computer 110. For example, the software on the drill supervisor computer 115 might have functionality to modify a drill plan created by the office computer 110, e.g., in response to unforeseen condition at the project site. In some embodiments, the drill supervisor computer 115 and the office computer 110 might be the same computer, or either computer might be omitted from the system. The drill supervisor computer can also communicate with the machines 105 and/or the office computer 110.

The communication between the office computer 110, the drill supervisor computer 115, and the machines 105 can take a variety of forms. Merely by way of example, each machine might have a control system (not illustrated on FIG. 1 that operates a version of the drill planning software or operates other software that can communicate with the drill planning software on the office computer 110 and/or the drill supervisor computer 115, either using standard communication facilities (e.g., IREDES) or proprietary communication formats. In some aspects, the control systems on the machines 105 might have a wireless communication interface (e.g., WiFi radio, LTE radio, and/or some other RF radio). This communication interface might be capable of directly communicating with the drill supervisor computer 105 and/or the office computer 110, as well as the other machines 105 in some cases, either over the air and/or via a network such as a cellular network, PSTN, the Internet, etc., such as in the case of an LTE or WiFi interface. In other cases, however, either due to the type of radio in the machines 105 or due to the distance involved, the system might include a communication hub 120, which might include a radio compatible with the radios in the machines 105 as well as another communication interface (e.g., WiFi, Ethernet, LTE) which can provide connectivity with a LAN or WAN (e.g., the Internet) to provide communication with the drill supervisor computer 115 and/or the office computer 110. In a particular embodiment, the drill supervisor computer 115 can serve as a communication hub 120 between the machines 105 and the office computer 110.

In other cases, the communication between the computers 110, 115 and the machines 105 might not be real time. For example, a drill plan might be loaded on portable media at the office computer 110 or the drill supervisor computer 115, and the portable media might be used to download the drill plan to each of the machines 105. Similarly, such portable media might be used to upload drilling statistics from the machines 105 to one of the computers 110, 115. The specific type of communication scheme is discretionary, so long as it provide the necessary communications between the various components of the system 100 to enable some or all of the functionality described herein. In any case, it should be noted that the communications can be two-way, in that the machines 105 can both receive information from, and provide information to, the office computer 110 and/or the drill supervisor computer.

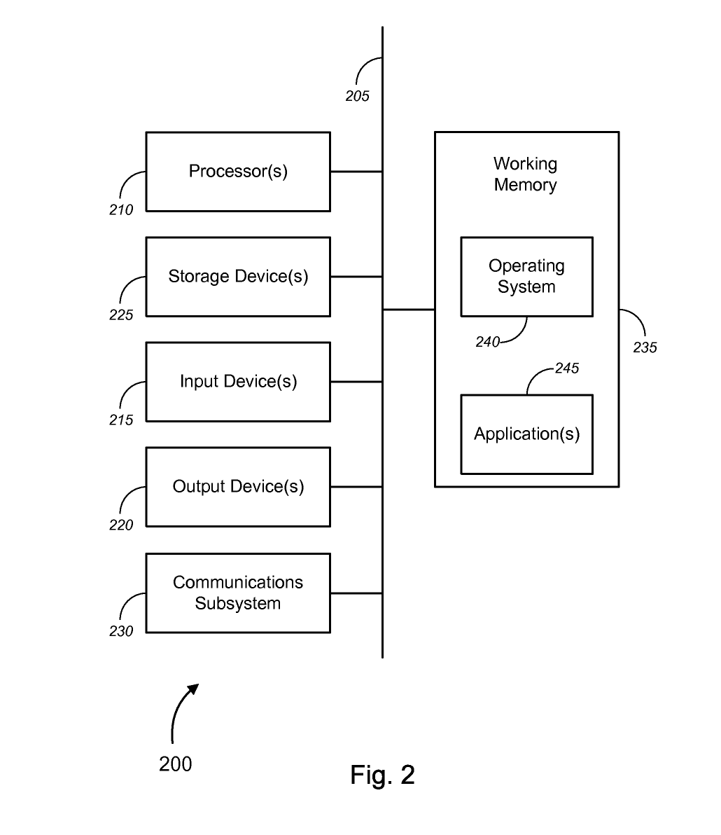

FIG. 2 provides a schematic illustration of one embodiment of a computer system 200 that can perform the methods provided by various other embodiments, as described herein, and/or can function as an office computer, drill supervisor computer, machine control system, and/or the like. It should be noted that FIG. 2 is meant only to provide a generalized illustration of various components, of which one or more (or none) of each may be utilized as appropriate. FIG. 2, therefore, broadly illustrates how individual system elements may be implemented in a relatively separated or relatively more integrated manner.

The computer system 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input devices 215, which can include without limitation a mouse, a keyboard and/or the like; and one or more output devices 220, which can include without limitation a display device, a printer and/or the like.

In general, embodiments can employ as a processor 210 any device (or combination of devices) that can operate to execute instructions to perform functions as described herein. Merely by way of example, and without limitation, any microprocessor (also sometimes referred to as a central processing unit, or “CPU”) can be used as the processor 210, including without limitation one or more complex instruction set computing (“CISC”) microprocessors, such as the single core and multicore processors available from Intel Corporation™ and others, such as Intel's X86 platform, including, e.g., the Pentium™, Core™, and Xeon™ lines of processors. Additionally and/or alternatively, reduced instruction set computing (“RISC”) microprocessors, such as the IBM Power™ line of processors, processors employing chip designs by ARM Holdings™, and others can be used in many embodiments. In further embodiments, a processor might be a microcontroller, embedded processor, embedded system, system on a chip (“SoC”) or the like.

As used herein, the term “processor” can mean a single processor or processor core (of any type) or a plurality of processors or processor cores (again, of any type) operating individually or in concert. Merely by way of example, the computer system 200 might include a general-purpose processor having multiple cores, a digital signal processor, and a graphics acceleration processor. In other cases, the computer system might 200 might include a CPU for general purpose tasks and one or more embedded systems or microcontrollers, for example, to run real-time functions. The functionality described herein can be allocated among the various processors or processor cores as needed for specific implementations. Thus, it should be noted that, while various examples of processors have been described herein for illustrative purposes, these examples should not be considered limiting.

The computer system 200 may further include (and/or be in communication with) one or more storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 200 might also include a communications subsystem 230, which can include without limitation a modem, a network card (wireless or wired), an infra-red communication device, a wireless communication device and/or chipset (such as a Bluetooth™ device, an 802.11 device, a WiFi device, an LTE device, a WiMax device, a WWAN device, cellular communication facilities, etc.), and/or the like. The communications subsystem 230 may permit data to be exchanged with a network (such as the network described below, to name one example), with other computer systems, and/or with any other devices described herein. In many embodiments, the computer system 200 will further comprise a working memory 235, which can include a RAM or ROM device, as described above.

The computer system 200 also may comprise software elements, shown as being currently located within the working memory 235, including an operating system 240, device drivers, executable libraries, and/or other code, such as one or more application programs 245, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 225 described above. In some cases, the storage medium might be incorporated within a computer system, such as the system 200. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 200 and/or might take the form of source and/or installable code, which, upon compilation and/or installation on the computer system 200 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 200) to perform methods in accordance with various embodiments of the invention. According to a set of embodiments, some or all of the procedures of such methods are performed by the computer system 200 in response to processor 210 executing one or more sequences of one or more instructions (which might be incorporated into the operating system 240 and/or other code, such as an application program 245) contained in the working memory 235. Such instructions may be read into the working memory 235 from another computer readable medium, such as one or more of the storage device(s) 225. Merely by way of example, execution of the sequences of instructions contained in the working memory 235 might cause the processor(s) 210 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 200, various computer readable media might be involved in providing instructions/code to processor(s) 210 for execution and/or might be used to store and/or carry such instructions/code (e.g., as signals). In many implementations, a computer readable medium is a non-transitory, physical and/or tangible storage medium. Such a medium may take many forms, including but not limited to, non-volatile media, volatile media, and transmission media. Non-volatile media includes, for example, optical and/or magnetic disks, such as the storage device(s) 225. Volatile media includes, without limitation, dynamic memory, such as the working memory 235. Transmission media includes, without limitation, coaxial cables, copper wire and fiber optics, including the wires that comprise the bus 205, as well as the various components of the communication subsystem 230 (and/or the media by which the communications subsystem 230 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 210 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 200. These signals, which might be in the form of electromagnetic signals, acoustic signals, optical signals and/or the like, are all examples of carrier waves on which instructions can be encoded, in accordance with various embodiments of the invention.

The communications subsystem 230 (and/or components thereof) generally will receive the signals, and the bus 205 then might carry the signals (and/or the data, instructions, etc. carried by the signals) to the working memory 235, from which the processor(s) 205 retrieves and executes the instructions. The instructions received by the working memory 235 may optionally be stored on a storage device 225 either before or after execution by the processor(s) 210.

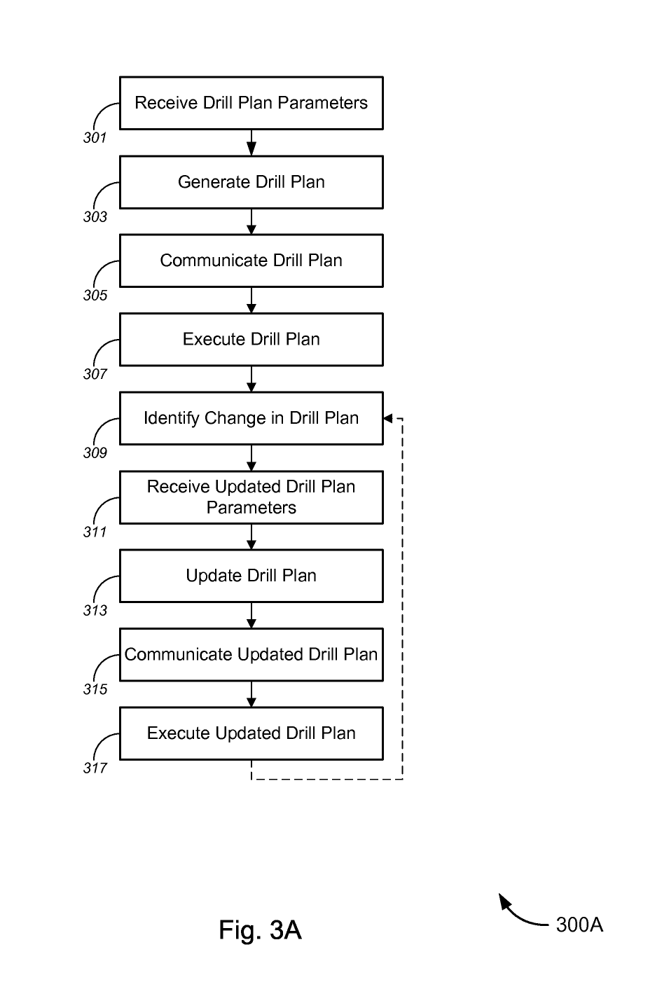

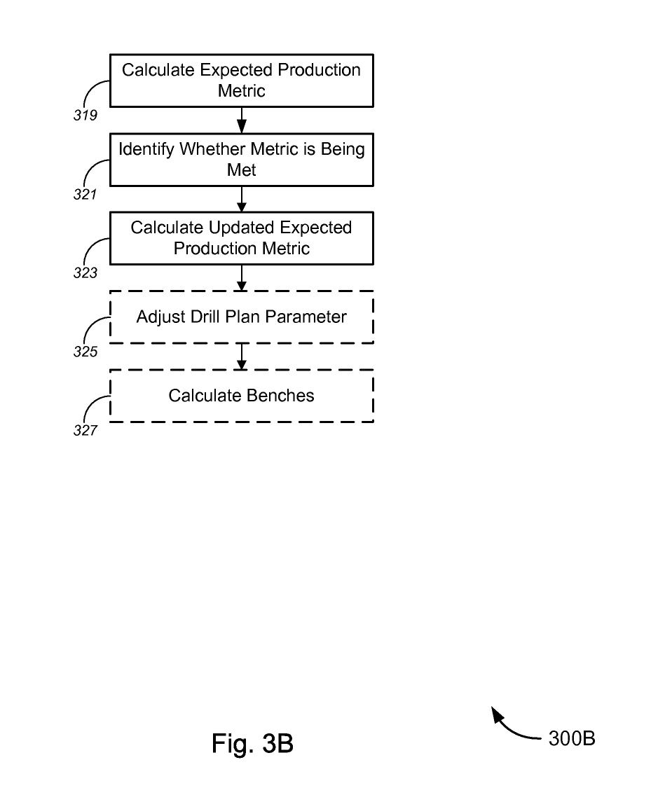

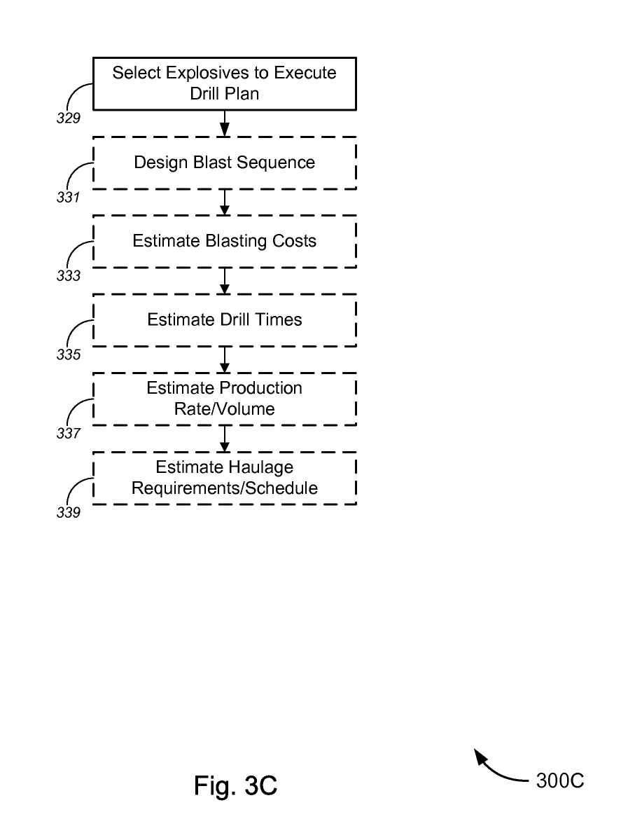

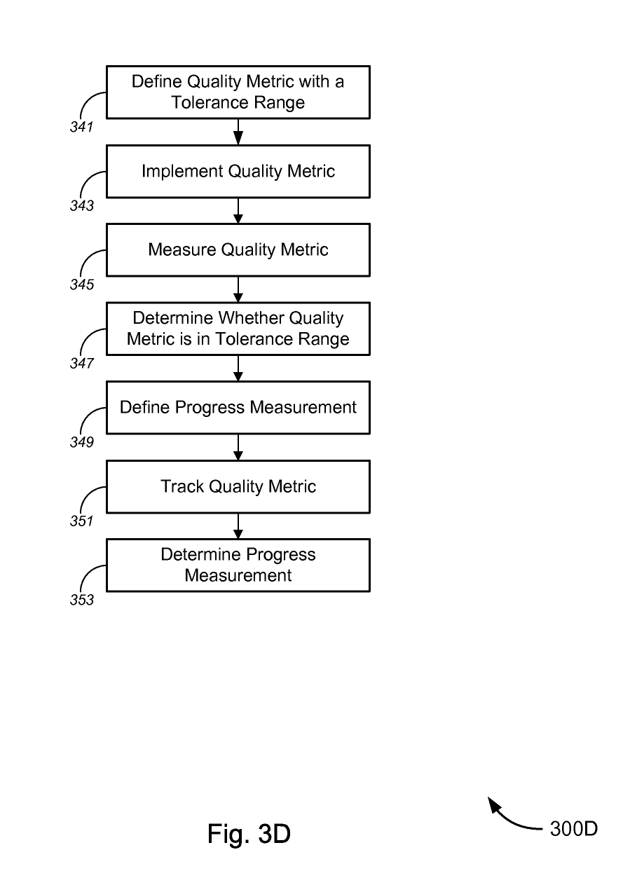

FIG. 3A provides a flow diagram of a method 300A for drill planning in accordance with various embodiments. The method 300A may be performed by the embodiments described in FIGS. 1 & 2, or combination of the above described embodiments. The method begins at block 301, where a computer system receives one or more drill plan parameters. In one set of embodiments, the computer system may be an office computer or drill supervisor, as described in the embodiments above. In these embodiments, the computer system may receive the one or more drill plan parameters from various sources, including, without limitation, from a user of drill planning software, extracted from a drill plan file, or retrieved from measurements taken by one or more machines at a project site.

At block 303, a drill plan is generated with the computer system, based on the one or more drill plan parameter. In various embodiments, the drill plan is a three-dimensional model that specifies positions, depths, and inclinations for each of the plurality of holes to be drilled in a construction project. In various embodiments, as described in the previous embodiments, the one or more drill plan parameters may include, without limitation, any parameter that may be modeled and incorporated as part of a drill plan. In a set of embodiments, the drill plan parameters may include, without limitation, design parameters related to a design surface, a surface model, rock surface model, machine and equipment specifications, drill hole depth and orientation, drill rate, material removal rate, operational costs and efficiency, projected timelines, and any other suitable parameters that may be modeled into the drill plan.

At block 305, the drill play is communicated to the one or more machines via the computer system. According to one set of embodiments, an extended IREDES standard may be utilized to transmit the drill plan to the one or more machines. In some embodiments, an office computer may directly transmit the drill plan to the one or more machines. In other embodiments, the office computer may transmit the drill plan first to an on-site drilling supervisor computer, which then relays the drill plan to the one or more machines. In yet further embodiments, the drill plan may directly be generated on a drilling supervisor computer and distributed to the one or more machines.

At block 307, the drill plan is executed by the one or more machines. In one set of embodiments, each of the one or more machines may operate according to the same drill plan. In various embodiments, the one or more machines may include, without limitation, a variety of different types of equipment, according to different project needs. For example, the MD5150 Track Drill™ from Caterpillar Inc. can be used as a drilling machine that is part of the one or more machines, as previously described in accordance with some embodiments. In some aspects, the one or more machines may include a control system for interfacing with other system elements, such as a drilling supervisor computer, office computer, a sensor mounted on the one or more machine, or other system element. The DPS900™, available from Trimble Navigation Limited, is one example of a control system that can be used in accordance with some embodiments. In various embodiments, the control system may receive the drill plan, various inputs, measurements, or commands from the other communicatively coupled devices. The control system may then, based on the drill plan, inputs, measurements, or commands, control an electrically coupled drilling/piling machine. For example, in some embodiments, the control system may navigate a motorized drilling/piling machine; control the position and angle of a drilling/piling arm of the drilling/piling machine; control the drill depth, drill speed, drill depth of the drilling/piling arm; or other such operation of a drilling/piling machine.

At block 309, the one or more machines identify a change in the drill plan. In various embodiments, the drill plan change may be a change in at least one of the one or more drill plan parameters upon which the drill plan was generated. This change may be detected by the one or more machines as changing conditions are encountered at the project site or during actual drilling/piling operations. For example, in one set of embodiments, the one or more machines may determine a deviation from the drill plan with regards to differences between the modeled surface and the actually encountered surface. Thus, one or more drill plan parameters related to the surface model may be identified as different from the actual conditions at the project site. In other embodiments, the one or more machines may calculate a deviation from the drill plan with regards to a production metric. For example, the one or more machines may be able to identify a difference in a modeled drilling rate and an actual drilling rate; modeled fuel consumption versus actual fuel consumption; the amount of material excavated by the drilling; the time it takes to complete a drill hole; or any other production metrics suitable to the project. Thus, one or more drill plan parameters related to the relevant production metric may be identified. In various embodiments, the one or more machines may detect, measure, or calculate these deviations from the drill plan via readings from one or more sensors coupled to the one or more drilling machine. In some embodiments, the sensors may be pre-existing sensors that are already integrated into the one or more machine, while in other embodiments external sensors may be added to the one or more machine.

At block 311, the at least one updated drill plan parameter is received by the computer system. In various embodiments, the one or more drilling/piling machines may directly transmit the updated drill plan parameter to the computer system. In other embodiments, the computer system may retrieve the updated drill plan parameters from the one or more machines, or a sensor of the one or more machines. In yet further embodiments, a drilling supervisor computer may transmit the at least one updated drill plan parameter to the computer system.

At block 313, the computer system updates the drill plan, in real-time, based on the at least one updated drill plan parameter. Thus, in various embodiments, the drill planning computer system may generate an updated drill plan based on the at least one updated drill plan parameter. The updating procedure may occur in real-time, as the updated drill plan parameters are identified and communicated to the drill planning computer system. In other embodiments, the drill plan may be updated with the at least one updated drill plan parameter on a periodic basis.

At block 315, the updated drill plan is communicated back to the one or more drilling/piling machines. In various embodiments, the updated drill plan may be communicated to the one or more drilling/piling machines in a manner substantially similar to how the original drill plan is communicated. In some embodiments, the updated drill plan may be transmitted to the one or more drilling/piling machines, or the drilling supervisor computer, in real-time as soon as the updated drill plan is generated. In other embodiments, the updated drill plan may be communicated back to the one or more machines, or the drilling supervisor computer, in a periodic manner.

At block 317, the updated drill plan is executed by the one or more machines. In various embodiments, the updated drill plan may include an adjustment made in response to the encountered condition at the project site. In some embodiments, the adjustment may occur in real-time, during operation of the one or more drilling/piling machines. The method may optionally monitor for changed conditions different from the updated drill plan, repeating the steps described at block 309 through block 317. In various embodiments, the loop may be executed continuously, and in real-time, or on a periodic basis.

FIG. 3B provides a flow diagram of a method 300B for additional operations that may be executed in combination with any of methods 300A, 300C, and 300D. The method 300B begins at block 319, where an expected production metric is calculated. In various embodiments, the production metric includes, without limitation, any suitable measure of production, project progress, estimated timelines and scheduled milestones, and operational costs associated with the drill plan. The drill planning computer system may thus calculate an expected production metric based on the one or more drill plan parameters.

At block 321, the one or more machines identifies whether the expected production is being met. In some embodiments, the expected production metric may be compared to calculated or measured actual production at the project site. As discussed with respect to the previous embodiments, the calculated or measured actual production may be derived via readings from the one or more drilling/piling machines themselves, or through sensors coupled to the one or more drilling/piling machines.

At block 323, the computer system updates the expected production metric based on the at least one updated drill plan parameter. Thus, as the drill plan parameters are updated, the expected production may be updated accordingly. For example, in one set of embodiments, a surface model may be updated to indicate differences in the type of material to be drilled. Thus, the updated surface model may allow a drill hole to be completed faster, or slower. The production metric may then be updated to reflect the change as appropriate.

At optional block 325, the drill planning computer system may further adjust at least one other drill parameter in order to maintain the expected production metric of the drill plan. In one set of embodiments, an expected production metric may correspond to an original drill plan. The expected production metric may specify a particular time period per drilled hole. Continuing with the previous example, if the updated drill plan parameter will result in an extended time period per drilled hole, another drill plan parameter may be changed to maintain the original expected time period per drilled hole. By way of example, if an updated surface model indicates a slower time to complete drill hole, the drilling rate of the drilling/piling machine may be increased to maintain the originally expected time to complete the drill hole. In this manner, the drill planning computer system may adjust a drill plan parameter and update the drill plan accordingly.

At optional block 327, the drill planning computer system generates a drill plan for a corridor, and corresponding to the corridor rill plan, the drill planning computer system may calculate a plurality of benches. Each of the benches may further have their own split and blast hole pattern.

FIG. 3C provides a flow diagram of a method 300C for additional optional processes related to the calculation of production metrics, in accordance with various embodiments. The method 300C begins at block 329, where the drill planning computer system selects at least one of a type, quantity, or mix of explosives to execute the drill plan.

At optional block 331, the drill planning computer system may further design a blast sequence to implement the drill plan, based on the one or more drill parameters. In various embodiments, the blast sequence itself may be a production metric. At optional block 333, the drill planning computer system estimates blasting costs associated with the drill plan, based on the one or more drill plan parameters. At optional block 335, the drill planning computer system estimates one or more drill times to execute the drill plan, based on the one or more drill plan parameters, the estimated drill time serving as a production metric. At optional block 337, the drill planning computer system estimates a production rate of material excavated by the drilling/piling machine, based on the one or more drill plan parameters. At optional block 339, the drill planning computer may further estimate a haulage requirement and a schedule to remove the excavated material, based on the one or more drill plan parameters.

FIG. 3D provides a flow diagram of a method 300D for additional processes in generating a drill plan, in accordance with various embodiments. At block 341, a quality metric is defined at a drill planning computer system. The quality metric includes at least a tolerance range to within which a measurement taken at a project site is acceptable. In various embodiments, quality metrics may be used as part of the generation of a drill hole quality report. The quality report may compare the quality of as-drilled holes to the planned drill holes of a drill plan. According to one set of embodiments, measurements and assessments of the quality of an as-drilled hole may be stored as a file, such as an IREDES file. In various embodiments, quality metrics may be defined for one or more drill holes collectively, for individual drill holes respectively, or as a combination of both collective and individual quality metrics.

At optional block 343, the quality metric may be implemented into the drill plan by the drill planning computer. In various embodiments, the quality metrics may be added to the drill plan as part of the drilling procedure specified by the drill plan. Thus, at optional block 345, the quality metric of an as-drilled drill hole may be measured by the one or more drilling/piling machines during execution of the drill plan. At optional block 347, the drill planning system may then determine whether or not the as-drilled hole is within the tolerance range for the specified quality metric.

Alternatively, in some embodiments, quality metrics may not be sent to the one or more drilling/piling machines. The one or more drilling/piling machines may instead gather work data on the as-drilled hole, such as measurements and other data gathered by one or more sensors, and transmits the work data of the as-drilled hole to the drill planning computer. The drill planning computer may then perform quality and production analysis on the work data of the as-drilled hole.

At optional block 349, a progress measurement may be defined at the drill planning computer system, based on the quality metric. Thus, a progress measurement may depend on quality metric itself. At optional block 351, the drill planning computer may track the quality metric for each as-drilled drill hole of a drill plan. At optional block 351, the drill planning computer system may then determine how much progress has been made on the progress measurement based on the number of drill holes determined to be within the tolerance range of the quality metric.

Although the method embodiments described above refer to the computer system as a drill planning computer system, it will be appreciated by those having ordinary skill in the art that any suitable computer system may be used that is capable of performing the above described procedures. For example, in some sets of embodiments, instead of a drill planning computer, a drilling supervisor computer, a controller located on the drilling/piling machine itself, or other suitable computer may execute some or all of the above processes as appropriate.

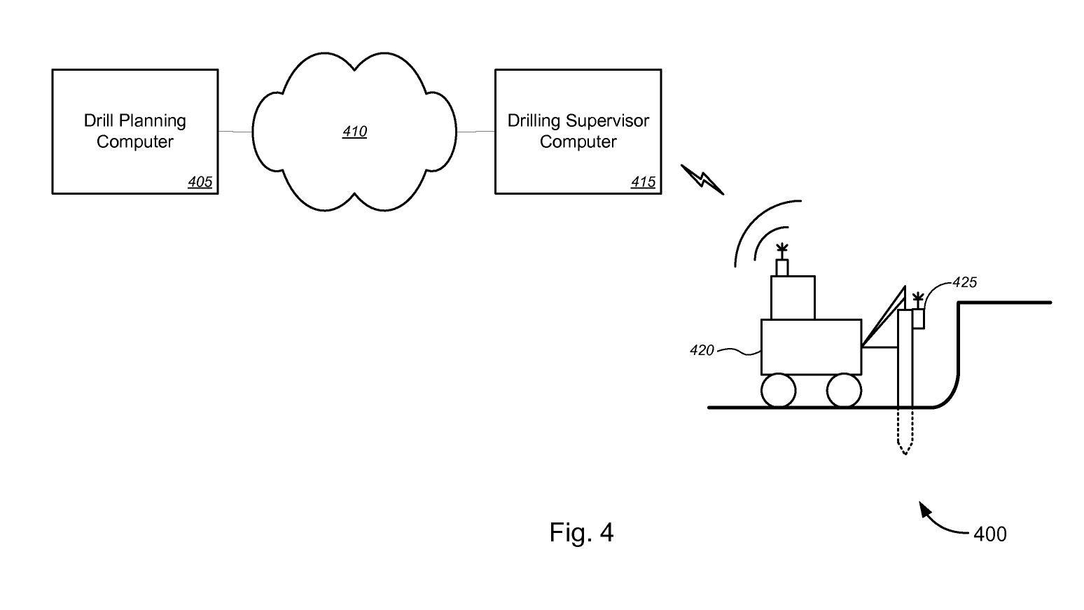

FIG. 4 is an exemplary system topology 400 for drill planning, according to various embodiments. The system topology 400 includes a drill planning computer communicatively coupled to a drilling supervisor computer 415 via communications network 410, the drilling supervisor computer in further communication with a drilling/piling machine 420 having one or more sensors 425. In various embodiments, the drill planning computer 405 may include an off-site system that generates a drill plan according to a parametric design. As discussed above with respect to the previous embodiments, drill plan parameters used by the drill planning computer 405 to generate the drill plan may be input directly to the drill plan computer by a user; imported from a design file such as, for example, an IREDES file; or retrieved by the drill planning computer from any of the drilling supervisor computer 415, drilling/piling machine 420, or sensor 425. According to one set of embodiments, once the drill plan has been generated, the drill planning computer 405 may communicate the drill plan to drilling supervisor computer 415 over a communications network 410. In other embodiments, the drill planning computer may communicate the drill plan directly to the drilling/piling machine 420. In yet further embodiments, the drilling supervisor computer 415 may be integrated into the drilling/piling machine 420 and may comprise all or part of a control system of the drilling/piling machine 420. In various embodiments, the communications network 410 may include any type of network familiar to those skilled in the art that can support data communications using any of a variety of commercially-available (and/or free or proprietary) protocols, including without limitation TCP/IP, SNA™, IPX™, AppleTalk™, and the like. Merely by way of example, the network $$10 can include a local area network (“LAN”), including without limitation a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; a cellular data network; and/or any combination of these and/or other networks.

In various embodiments, the drilling supervisor computer 415 may be, without limitation, a laptop computer, a tablet computer, a specialized handset, a smart phone, or the like, generally located at, or in close proximity to, the project site. In some embodiments, the drilling supervisor computer 415 may be a communications hub between the drill planning computer 405 and drilling/piling machine 420. In some further embodiments, the drilling supervisor computer 415 may itself be integrated into the drilling/piling machine 420. Thus, the drilling supervisor 415 computer 415 may further include some or all of the control system of drilling/piling machine 420. In yet further embodiments, the drilling supervisor 415 may alternatively be an on-site version of the drill planning computer 405. In one set of embodiments, the drilling supervisor computer 415 may be in wireless communication with the drilling/piling machine 420. In other embodiments, the drilling supervisor computer 415 may utilize wired communications to, or may be integrated into the control system of the drilling/piling machine 420. Accordingly, when the drilling supervisor computer 415 receives the drill plan from drill planning computer 405 via communications network 410, the drilling supervisor computer 415 may directly control or send instructions to the drilling/piling machine 420 to execute the drill plan.

The drilling/piling machine 420 executing the drill plan may further include one or more sensors 425. In various embodiments, the one or more sensors 425 may be integrated sensors of the drilling/piling machine 420, or may be externally added sensors. In some embodiments, the one or more sensors 425 may independently communicate with the drilling supervisor computer 415 or drill planning computer 405. In other embodiments, readings from the one or more sensors 425 may be communicated by the drilling/piling machine 420. The drilling/piling machine 420 may include systems to navigate to a location specified in a drill plan, and to control the position and orientation of any of the robotic arm, leads, drill, or piling hammer. The drilling/piling machine 420 may rely on the one or more sensors 425 to make these adjustments to position and orientation. In various embodiments, the one or more sensors 425 may further identify conditions as the drilling operation is performed that are different from those modeled in the drill plan. The one or more sensors 425 may then communicate the measurements of the changed conditions to the drilling/piling machine 420, drilling supervisor computer 415, or drill planning computer 405 to be used as an updated drill plan parameter with which to update or create an updated drill plan. The updated drill plan may then be communicated by the drill planning computer 405 or drilling supervisor computer 415 to the drilling/piling machine 420. The drilling/piling machine 420 may then make adjustments as necessary to implement the updated drill plan. In various embodiments, these processes may occur substantially in real-time allowing for on-the-fly adjustments to the drilling/piling operation. In other embodiments, the updating process may occur at scheduled times, or on a periodic basis.

In another set of embodiments, the one or more sensors 425 may further track progress made on a drilling operation, as well as monitor the quality of the as-drilled holes. In various embodiments, the drill plan itself may specify a quality metric against which measurements of the one or more sensors 425 may be compared. In various embodiments, the comparison may occur as part of generating a quality report, initiated at one of a drill planning computer 420 or drilling supervisor computer 415.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computer system, one or more drill plan parameters;
generating, with the computer system, a drill plan based on the one or more drill plan parameters, the drill plan comprising a three-dimensional model specifying positions, depths, and inclinations for a plurality of holes to be drilled in a construction project;
communicating, via the computer system, the drill plan to one or more machines;
executing, with the one or more machines, the drill plan to drill one or more holes in a material, in accordance with the drill plan;
identifying, with at least one of the one or more machines, a change in at least one of the one or more drill plan parameters corresponding to at least one of a calculation or measurement based on conditions at a project site;
receiving, with the computer system, an at least one updated drill plan parameter, the at least one updated drill plan parameter being based on the at least one of the calculation or measurement of conditions at the project site;
updating, with the computer system, the drill plan in real-time based on the at least one updated drill plan parameter to create an updated drill plan;
communicating, via the computer system, the updated drill plan to the one or more machines; and
executing, with the one or more machines, the updated drill plan to drill one or more holes in a material, in accordance with the updated drill plan, wherein operation of the one or more machines previously executing the drill plan are adjusted in real-time to reflect changes made by the updated drill plan.

2. The method of claim 1, wherein communicating the drill plan to one or more machines comprises communicating a minimum drill depth parameter to the one or more machines, and wherein executing the drill plan comprises each of the one or more machines drilling each bore hole to at least a depth specified by the minimum drill depth parameter.

3. The method of claim 1, wherein the drill plan parameter is a positional element, indicating at least one of a geographic position, drill orientation, inclination, elevation, and tilt.

4. The method of claim 1, wherein the drill plan parameter is tied to a production metric, the method further comprising:
calculating, based on the one or more drill plan parameters, an expected production metric associated with the drill plan;
identifying, with the at least one of the one or more machines, whether the expected production metric is being met; and
calculating, with the computer system, an updated expected production metric based on the at least one updated drill plan parameter.

5. The method of claim 4, further comprising:
automatically adjusting, with the computer, at least one other drill plan parameter of the one or more drill plan parameter to maintain the expected production metric of the drill plan;
wherein the updated drill plan reflects the adjustments to maintain the expected production metric of the drill plan.

6. The method of claim 1, wherein generating a drill plan comprises generating a corridor drill plan, further comprising:
automatically calculating, with the computer system, a plurality of benches, each bench having its own split and blast hole pattern.

7. The method of claim 4, further comprising:
automatically selecting, with the computer system, at least one of a type, a quantity, and a mix of explosives necessary to execute the drill plan, based on the one or more drill plan parameters, wherein the type, quantity, and mix are each expected production metrics.

8. The method of claim 7, further comprising:
automatically designing, with the computer system, a blast sequence to implement the drill plan, based on the one or more drill plan parameters, wherein the blast sequence is one of the expected production metrics.

9. The method of claim 7, further comprising:
automatically estimating, with the computer system, blasting costs associated with the drill plan, based on the one or more drill plan parameters, wherein the blasting costs are expected production metrics.

10. The method of claim 7, further comprising:
automatically estimating, with the computer system, one or more drill times to execute the drill plan, based on the one or more drill plan parameters, wherein the drill times are expected production metrics.

11. The method of claim 7, further comprising:
automatically estimating, with the computer system, at least one of production volumes or production rates of material excavated by executing the drill plan, based on the one or more drill plan parameters, wherein the production volumes and production rates are each expected production metrics.

12. The method of claim 11, wherein managing a project further comprises:
automatically estimating, with the computer system, at least one of haulage requirements or schedule to remove the material excavated, based on the one or more drill plan parameters, wherein the haulage requirements and schedule to remove the material are each expected production metrics.

13. The method of claim 1, further comprising:
defining, at the computer system, a quality metric, the quality metric including at least a tolerance range;
implementing, with the computer system, the quality metric into the drill plan;
measuring, with the one or more machines, the quality metric for a drill hole, as drilled by the one or more machines; and
determining, with the computer system, whether the quality metric as measured for the drill hole is within the tolerance range.

14. The method of claim 13, further comprising:
defining, with the computer system, a progress measurement based on the quality metric;
tracking, via the computer system, the quality metric for each drill hole of a drill plan; and
determining, with the computer system, progress made on the progress measurement based on a number of drill holes determined to be within the tolerance range.

15. A drill planning computer, comprising:
one or more processors;
a communications interface in communication over a communications network, wherein the communications interface is communicatively coupled to one or more machines of a drilling operation; and
a non-transitory computer readable medium in communication with the one or more processors, the computer readable medium having encoded thereon a set of instructions executable by the one or more processors to:
receive one or more drill plan parameters;
generate a drill plan based on the one or more drill plan parameters;
communicate, via the communications interface, the drill plan to one or more machines;
receive, via the communications interface, a change in at least one of the one or more drill plan parameters corresponding to at least one of a calculation or measurement based on conditions at the project site by the one or more machines;
update the at least one of the one or more drill plan parameters based on the change;
update the drill plan in real-time based on the at least one updated drill plan parameter to create an updated drill plan;
transmit, via the communications interface, the updated drill plan to the one or more machines; and
adjust, in real-time, operation of the one or more machines to reflect the changes in the updated drill plan.

16. The drill planning computer of claim 15, wherein the set of instructions further executable by the one or more processors to:
calculate, based on the one or more drill plan parameters, an expected production metric associated with the drill plan;
identify, with the at least one of the one or more machines, whether the expected production metric is being met; and
calculate an updated expected production metric based on the at least one updated drill plan parameter.

17. The drill planning computer of claim 15, wherein the set of instructions further executable by the one or more processors to:
define a quality metric, the quality metric including at least a tolerance range;
implement the quality metric into the drill plan;
measure, via the one or more machines, the quality metric for a drill hole as drilled by the one or more machines;
receive, via the communications interface, the measurement of the quality metric from the one or more machines; and
determine whether the quality metric as measured for the drill hole is within the tolerance range.

18. A system comprising:
one or more drilling machines at a drilling site, the one or more drilling machines comprising a communications interface and one or more sensors;
a drilling supervisor computer in communication over a communications network, the drilling supervisor communicatively coupled to the one or more drilling machines;
a drill planning computer, comprising:
one or more processors;
a network interface communicatively coupled to the communications network, wherein the network interface is in communication with the drilling supervisor and the one or more drilling machines via the communications network; and
a non-transitory computer readable medium in communication with the one or more processors, the computer readable medium having encoded thereon a set of instructions executable by the one or more processors to:
receive one or more drill plan parameters;
generate a drill plan based on the one or more drill plan parameters;
communicate, via the communications interface, the drill plan to one or more machines;
retrieve, from at least one of the one or more machines, a change in at least one of the one or more drill plan parameters corresponding to at least one of a calculation or measurement based on conditions at the project site;
update the at least one of the one or more drill plan parameters based on the change;
update the drill plan in real-time based on the at least one updated drill plan parameter to create an updated drill plan;
transmit, via the communications interface, the updated drill plan to the one or more machines; and
adjust, in real-time, operation of the one or more machines to reflect the changes in the updated drill plan;
wherein the drilling supervisor computer receives the updated drill plan from the drill planning computer and controls at least one of the drilling machines to execute the updated drill plan by drilling one or more holes.

19. The drill planning system of claim 18, wherein the set of instructions further executable by the one or more processors to:
calculate, based on the one or more drill plan parameters, an expected production metric associated with the drill plan;
identify, with the at least one of the one or more machines, whether the expected production metric is being met; and
calculate an updated expected production metric based on the at least one updated drill plan parameter.

20. The drill planning system of claim 18, wherein the set of instructions further executable by the one or more processors to:
define a quality metric, the quality metric including at least a tolerance range;
implement the quality metric into the drill plan;
measure, via the one or more machines, the quality metric for a drill hole as drilled by the one or more machines;
receive, via the communications interface, the measurement of the quality metric from the one or more machines; and
determine whether the quality metric as measured for the drill hole is within the tolerance range.
